(19) United States
(12) Patent Application Publication
(10) Pub. No.: US 2025/0086246 A1
(43) Pub. Date: Mar. 13, 2025

(54) Landing Page Optimization Using Machine-Learning Techniques

(71) Applicant: Google LLC, Mountain View, CA (US)

(72) Inventors: Srinivas Varanasi, Bangalore (IN); Nidhi Gupta, Bangalore (IN); Abhinav Khandelwal, Bengaluru (IN); Alper Halbutogullari, Santa Clara, CA (US); Andreas Born, Zurich (CH); Dongcai Shen, Mountain View, CA (US); Siva Kumar Gorantla, Sunnyvale, CA (US); JYoung S Kim, Sunnyvale, CA (US)

(21) Appl. No.: 18/774,733

(22) Filed: Jul. 16, 2024

(30) Foreign Application Priority Data
Sep. 12, 2023 (IN) IN202321061200

(51) Int. Cl. G06F 16/958; G06N 20/00

(52) U.S. Cl. CPC G06F 16/958; G06N 20/00

(57) ABSTRACT

Methods, computing systems, and technology for optimizing a landing page of a website are presented. The system can receive, from a user device, a first web address associated with a first webpage of the website. The system can process, using the machine-learned assessment model, the first webpage to generate a first landing page score. The system can determine, based on the first landing page score and using a machine-learned optimization model, an actionable suggestion associated with the landing page. The system can cause, on a display of the user device, a presentation of the actionable suggestion.

### FIELD

The present disclosure relates generally to automatically generating and optimizing landing pages for websites using machine-learning techniques. More particularly, the present disclosure relates to using machine-learning techniques for assessing a current landing page of a website and making suggestions to improve the current landing page based on the assessment.

### BACKGROUND

Poor landing page quality refers to web pages that do not effectively meet the needs and expectations of users, ultimately leading to a negative user experience. The quality of a landing page can impact the user experience and influence website sales. A well-designed, user-friendly, and relevant landing page can increase conversion rates and drive sales, while a poor-quality landing page can have the opposite effect, causing potential customers to leave the site without taking any action. Therefore, improving landing page quality can improve user experience and conversion rates.

### SUMMARY

Aspects and advantages of embodiments of the present disclosure will be set forth in part in the following description, or can be learned from the description, or can be learned through practice of the embodiments.

One example aspect of the present disclosure is directed to a computing system for optimizing landing pages. The computing system can include one or more processors and one or more non-transitory computer-readable media. The computer-readable media can store a machine-learned assessment model configured to assess a web page of a website and a machine-learned optimization model configured to optimize a landing page of the website. The computing system can include instructions that, when executed by the one or more processors, cause the computing system to perform operations. The operations can include receiving, from a user device, a first web address associated with a first webpage of the website. The first web page is a landing page of a sponsored content. The operations can include processing, using the machine-learned assessment model, the first webpage to generate a first landing page score. The first landing page score can be calculated based on a plurality of assets of the first landing page. The operations can include determining, based on the first landing page score and using the machine-learned optimization model, an actionable suggestion associated with the landing page. The operations can include causing, on a display of the user device, a presentation of the actionable suggestion.

In some instances, the actionable suggestion can be to modify an asset in the plurality of assets of the first webpage, use a second webpage of the website as the landing page, or generate a new webpage based on the plurality of assets. Additionally, the actionable suggestion can be further determined based on the first landing page score exceeding a threshold value.

In some instances, the system can process, using the machine-learned assessment model, a second webpage of the website to generate a second landing page score. Additionally, the actionable suggestion can be to update the landing page of the website to be the second webpage when the second landing page score is greater than the first landing page score.

In some instances, the system can process, using the machine-learned assessment model, a second webpage of the website to generate a second landing page score. Additionally, the actionable suggestion can be to maintain the landing page of the website to be the first web page when the second landing page score is less than the first landing page score.

In some instances, the actionable suggestion can be to dynamically generate a new webpage as the landing page when the first landing page score is below a threshold value. Additionally, the new webpage can be generated using the machine-learned optimization model by extracting the plurality of assets from the first webpage to generate a new asset for the new webpage.

Furthermore, the system can process, using the machine-learned assessment model, the new webpage to generate a new landing page score. Moreover, the system can modify, using the machine-learned optimization model, the new webpage until the new landing page score is above a threshold value. The actionable suggestion can be to update the landing page of the website to the new webpage.

In some instances, the first landing page score can be generated by extracting the plurality of assets from the first web page. Each asset in the plurality of assets can be an image, a word, a video, or an audio file. Additionally, the system can process, using the machine-learned optimization model, the plurality of assets to generate the first landing page score.

In some instances, the actionable suggestion can be to modify an asset in the plurality of assets of the first webpage when the first landing page score is above a threshold value.

In some instances, the landing page score can be a four-point scale. For example, the landing page score can be either poor, average, good, or excellent.

In some instances, the system can receive a user interaction on a graphical user interface of the display. The user interaction can be associated with a response to the actionable suggestion. Additionally, the system can perform, using the machine-learned optimization model, an action based on the user interaction. Moreover, one or more parameters of the machine-learned assessment model and the machine-learned optimization model can be updated based on the user interaction.

In some instances, the system can receive a user interaction on the graphical user interface. For example, the user interaction can be to reject the actionable suggestion. Additionally, one or more parameters of the machine-learned optimization model are updated based on the user interaction.

In some instances, the first web page can be a Uniform Resource Locator (URL) of the website.

In some instances, the first landing page score is based on a relevance sub-score, the relevance sub-score being based on a relevance of the first webpage and a sponsored content having the first web address associated with the first webpage.

In some instances, the first landing page score is based on a content quality sub- score, the content quality sub-score based on attributes of the plurality of assets of the first webpage.

In some instances, the first landing page score is based on a trust sub-score associated with a trust factor of the first webpage.

In some instances, the first landing page score is based on a load time sub-score, a mobile responsiveness sub-score, and a call-to-action sub-score. The load-time sub-score can be based on an amount of time it takes for the first webpage to load on the display of the user device. The mobile responsiveness sub-score is based on an amount of time it takes for the first webpage to load on a mobile device. The call-to-action sub-score can be based on the accuracy and/or relevance of an action associated with a call-to-action button.

Another example aspect of the present disclosure is directed to a computer- implemented method for optimizing a landing page. The method can include receiving, from a user device, a first web address associated with a first webpage of the website. The first webpage can be a landing page of a content item. Additionally, the method can include processing, using a machine-learned assessment model, the first webpage to generate a first landing page score. The machine-learned assessment model can be configured to calculate the first landing page score based on assets of the first webpage. Moreover, the method can include determining, based on the first landing page score and using a machine-learned optimization model, an actionable suggestion associated with the landing page. The machine-learned optimization model can be configured to optimize the landing page. Furthermore, the method can include causing, on a display of the user device, a presentation of the actionable suggestion.

Another example aspect of the present disclosure is directed to one or more non-transitory, computer readable media storing instructions that are executable by one or more processors to cause a computing system to perform operations. The operations can include receiving, from a user device, a first web address associated with a first webpage of the website. The first webpage can be a landing page of a content item, such as a sponsored content. Additionally, the operations can include processing, using a machine-learned assessment model, the first webpage to generate a first landing page score. The machine-learned assessment model can be configured to calculate the first landing page score based on assets of the first webpage. Moreover, the operations can include determining, based on the first landing page score and using a machine-learned optimization model, an actionable suggestion associated with the landing page. The machine-learned optimization model can be configured to optimize the landing page. Furthermore, the operations can include causing, on a display of the user device, a presentation of the actionable suggestion.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example system for implementing a machine-learned landing page optimization pipeline.

FIG. 2 depicts a block diagram of an example system according to example embodiments of the present disclosure.

FIG. 3 depicts an example illustration of assessing landing page quality during campaign construction.

FIG. 4 depicts an example illustration of automated actionable suggestions during campaign construction.

FIG. 5 depicts an example illustration of the system presenting recommendations during campaign construction.

FIG. 6 depicts an example illustration of presenting actionable suggestions after the campaign construction.

FIG. 7 depicts an example illustration of generating a new web page to be used as the landing page after campaign construction.

FIG. 8 depicts an example illustration of suggestions to improve assets in the landing page.

FIG. 9 depicts an example illustration of suggestions to improve assets in the landing page.

FIG. 10A depicts a block diagram of an example computing system that performs guided content generation according to example embodiments of the present disclosure.

FIG. 10B depicts a block diagram of an example computing device that performs guided content generation according to example embodiments of the present disclosure.

FIG. 10C depicts a block diagram of an example computing device that performs guided content generation according to example embodiments of the present disclosure.

FIG. 11 depicts a flow chart diagram of an example method to generate media assets according to example embodiments of the present disclosure.

Reference numerals that are repeated across plural figures are intended to identify the same features in various implementations.

### DETAILED DESCRIPTION

### Overview

Generally, the present disclosure is directed to artificial intelligence (AI) powered landing page quality optimization and automation. The system described herein can present actionable suggestions to entities (e.g., companies) to improve the landing page and optimize the experience for target users based on a landing page score associated with the quality of the landing page. In some instances, poor landing page quality can adversely affect companies. For example, a landing page can be the first interaction a user has with a website of a company. A negative first impression can occur when a landing page appears unprofessional, lacks relevant content, or has a confusing layout.

In some instances, poor landing page quality can have an impact on the performance of a website. The system described herein enables landing page quality automation using machine-learning techniques. Machine-learned (ML) models can determine a landing page score and generate actionable suggestions based on the landing page score. The system, using the ML models, can provide actionable suggestions for improving performance, trustworthiness, usability, and relevance of web pages, which can help businesses get better marketing performance. The actionable suggestions can also be aligned with how a user is searching and seeking information.

As background, a computer can execute instructions to generate outputs provided some input(s) according to a parameterized model. The computer can use an evaluation metric to evaluate its performance in generating the output with the model. The computer can update the parameters of the model based on the evaluation metric to improve its performance. In this manner, the computer can iteratively “learn” to generate the desired outputs. The resulting model is often referred to as a machine-learned (ML) model.

According to some embodiments, the system, using the ML models, can suggest a preferred webpage (e.g., Uniform Resource Locator (URL)) during an advertisement campaign setup. The system can also generate reports with actionable suggestions on landing page quality improvements to be shared with users (e.g., webmasters and other stakeholders in an organization).

A third-party entity (e.g., company) can connect to users through websites or landing pages that the third-party has created. Businesses use landing pages to help their users find the products and services a user is looking for, and to build trust with the user. The quality of the landing page (e.g., relevance, usability, trustworthiness, performance) dictates the nature of the action the user would take and how beneficial the interaction is for the advertiser based on the campaign goals.

However, the low quality of landing pages has been identified to be one of the biggest challenges for delivering value to the advertisers. Such low quality landing pages lead to issues where the users might find content irrelevant, unstructured, and non-trustworthy which can lead to lower conversions. A high quality landing page is one of the key resources that is provided by the advertiser that could help power the automation.

According to some embodiments, the system can determine a landing page score by analyzing the content (e.g., plurality of assets) of the landing page. The system can automate identification of the quality of landing page with a landing page score and determine actionable suggestions for the advertiser to improve the landing page quality score.

The landing page score can be based on a plurality of sub-scores. For example, the landing page score can be based, in part, on a relevance sub-score. The relevance sub-score can determine the relevance of a landing page with the source (e.g., sponsored content) that brought the user to the landing page. The relevance sub-score can be based on the alignment between the landing page and the source. For example, the more aligned the landing page is to the source, the higher the relevance sub-score. A relevance sub-score may be low when the landing page does not match the expectation of the sponsored content, and thus may be misleading.

Additionally, the system can determine the landing page score based on a content quality sub-score. The content quality sub-score can be based on attributes (e.g., how well written and informative) of the content in the landing page. For example, website users prefer to find information quickly and easily. A landing page with poorly written, uninformative, or irrelevant content can deter potential users.

Moreover, the system can determine the landing page score based on a load-time sub-score. Slow-loading landing pages can frustrate users and lead to high bounce rates. Slow page-load can negatively impact the user experience and deter potential buyers.

Furthermore, the system can determine the landing page score based on a mobile responsiveness sub-score. The system can determine the responsiveness of a landing page that is displayed on a mobile device (e.g., smartphones, tablets). For example, the landing page can receive a low mobile responsiveness sub-score when the landing page does not display well on smartphones and tablets, which can result in poor user experience.

The system can determine the landing page score based on a call-to-action sub-score. A well-designed call-to-action can be important for guiding users toward conversion. For example, the landing page can have a low call-to-action sub-score when the landing page lacks a clear and compelling call-to-action, which results in a user not knowing what action (e.g., making a purchase, signing up for a newsletter, or contacting customer support) to take next.

The system can determine the landing page score based on a trust sub-score. The trust sub-score can be determined based on trust, credibility, and/or other factors. For example, low quality landing pages can erode trust, as users may question the legitimacy of the website. In order to protect user's information, including payment information, the landing page has to display trust, credibility, and other factors.

The landing page score can use machine learning to identify what inputs from the landing page truly determine the user behavior and hence the landing page quality. With these inputs the score would be classified into a four point scale of ‘Poor’, ‘Average’, ‘Good’, ‘Excellent.’ The landing page score can be at an advertisement level and can be available both during and post campaign construction.

The system can suggest to the advertiser the actions that they can take to improve the landing page quality score from one bucket to the other. It would also provide insights on improving performance, trustworthiness, usability, and relevance of the landing pages which helps businesses get better ad performance. The actionable insights are also aligned with how users search and seek information. If the websites already exist but are of poor quality, the system, using ML models, can provide suggestions for better descriptions of products and services, page layouts, high quality images, and so on. The system can also suggest a preferred URL during campaign setup that could boost the quality.

In some instances, actionable suggestions can include dynamically generating new web pages to be used as the landing page. The system, using ML models, can generate a new web page based on business information like business name, category, vertical and some images would be used to auto generate good quality landing pages that are trustworthy, conversion tracked and work better from an ads point of view.

Additionally, the system can generate and present downloadable reports with actionable suggestions on landing page quality improvements, view mock websites to be shared with webmasters and other stakeholders.

Examples of the disclosure provide several technical effects, benefits, and/or improvements in computing technology and artificial intelligence techniques that involve the use of machine learning algorithms to generate new data, such as images, audio, text, video, or other types of media. The techniques described herein improve the use of generative models by improving the quality of the generated content. The quality of the generated content is tailored specifically to the entity (e.g., company, user) by using data extracted from a web resource of the entity. For example, by using more content-relevant data, the system improves the performance of generative models. Additionally, the system utilizes better training techniques by developing more efficient and effective training techniques that are specific to the entity (e.g., based on data extracted from a web resource of the entity) to reduce the time and resources required to train models. Moreover, the system can incorporate user feedback and provide the feedback, via reinforcement learning or active learning, to generative models that can help the models learn from user preferences and improve over time. Furthermore, the present disclosure can reduce processing by reducing the number of manual inputs provided by a user and by reducing the number of interface screens which must be obtained, loaded, interacted with, and updated. For example, the user may only have to input a web address of a website, and the system can automatically extract content from the website and automatically generate content items for the user.

With reference now to the Figures, example embodiments of the present disclosure will be discussed in further detail.

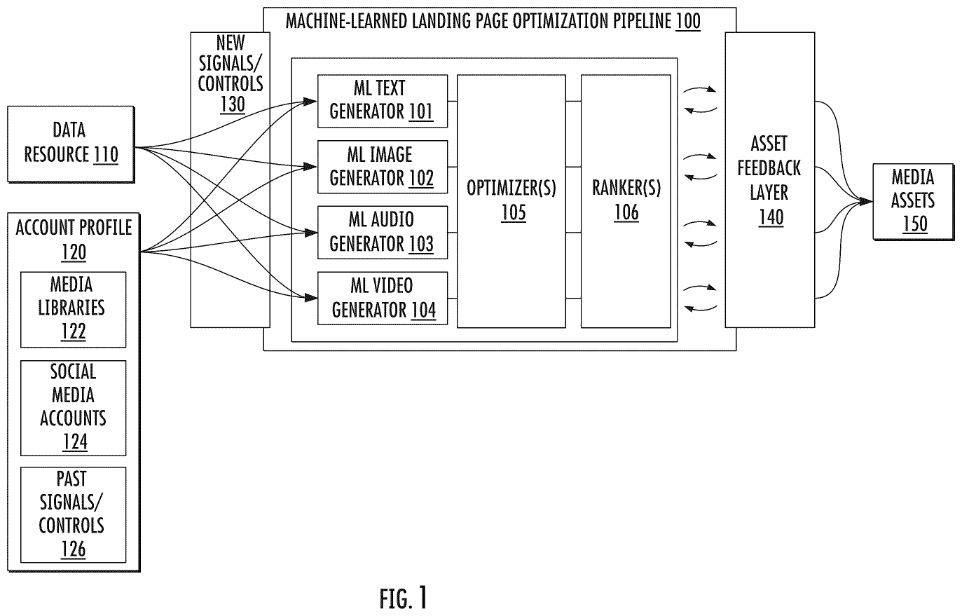

FIG. 1 depicts an example system for implementing a machine-learned landing page optimization pipeline 100. Machine-learned landing page optimization pipeline 100 can include a machine-learned text generator 101. Machine-learned landing page optimization pipeline 100 can include a machine-learned image generator 102. Machine-learned landing page optimization pipeline 100 can include a machine-learned audio generator 103. Machine-learned landing page optimization pipeline 100 can include a machine-learned video generator 104. Machine-learned landing page optimization pipeline 100 can include one or more optimizer(s) 105 to apply one or more optimization algorithms to the outputs of any one or more of machine-learned generator models 101 to 104. Machine-learned landing page optimization pipeline 100 can include one or more ranker(s) 106 to rank outputs of any one or more of machine-learned generator models 101 to 104.

Machine-learned landing page optimization pipeline 100 can ingest data from a webpage 110 and data from an account profile 120. Account profile 120 can include media asset preferences. Account profile 120 can include media libraries 112. Account profile 120 can include social media accounts 124. Account profile 120 can include past signals/controls 126 input to the machine-learned landing page optimization pipeline 100. Machine-learned landing page optimization pipeline 100 can process the data retrieved from a webpage 110 and account profile 120 to generate a landing page score 130. The landing page score 130 can include a plurality of sub-scores 135.

Machine-learned landing page optimization pipeline 100 can include a feedback layer 140. The feedback layer 140 can facilitate input of user feedback on actionable suggestions. After selection, confirmation, or approval using the feedback layer 140, machine-learned landing page optimization pipeline 100 can optimize a landing page 150. The optimization of a landing page 150 can include modifying an asset in the first web page of a website 155, suggesting a second webpage of the website to be the landing page 160, or dynamically generating a new webpage to be the landing page 165.

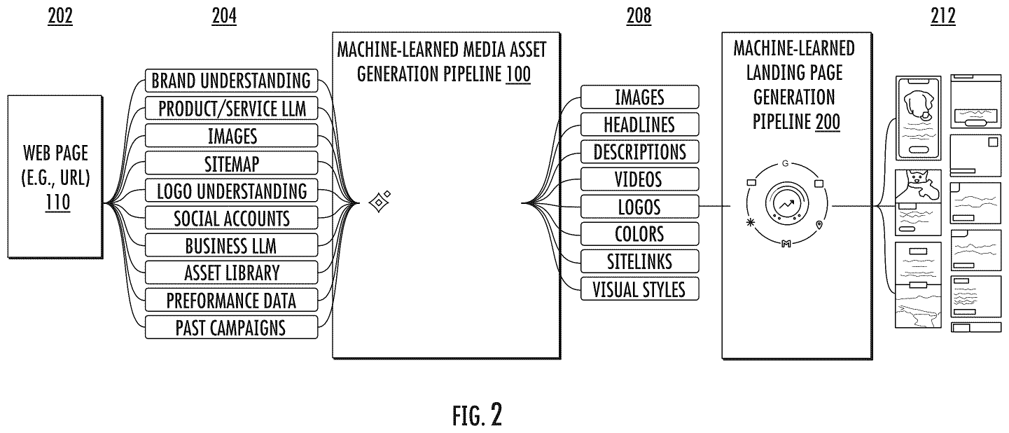

FIG. 2 depicts a block diagram 200 of an example system according to example embodiments of the present disclosure. The system can receive a URL 202 from a user. For example, the system can receive, from a user device of a user, user input associated with the URL. The system can extract a plurality of assets 204 from a webpage 110 associated with the URL 202. The plurality of assets 204 can include brand understanding, product, and service large language model (LLM), images, sitemap, logo understanding, social accounts, business LLM, asset library, performance data, past campaign data. Additionally, the system, machine-learned landing page optimization pipeline 100 can process the plurality of assets 204 to generate the plurality of content items 208. The overall model 206 can perform ranking and insights determination, text and/or image generative artificial intelligence, asset auto-generate, stock lockups, product generation, and video creation. The plurality of content 208 can include images, headlines, descriptions, videos, logos, colors, sitelinks, and visual styles. The system can use a machine-learned landing page generation pipeline 200 to determine the selected media assets from the plurality of media assets to generate content items 212. Subsequently, the system can cause the presentation of a new content item on a graphical user interface displayed on a user device.

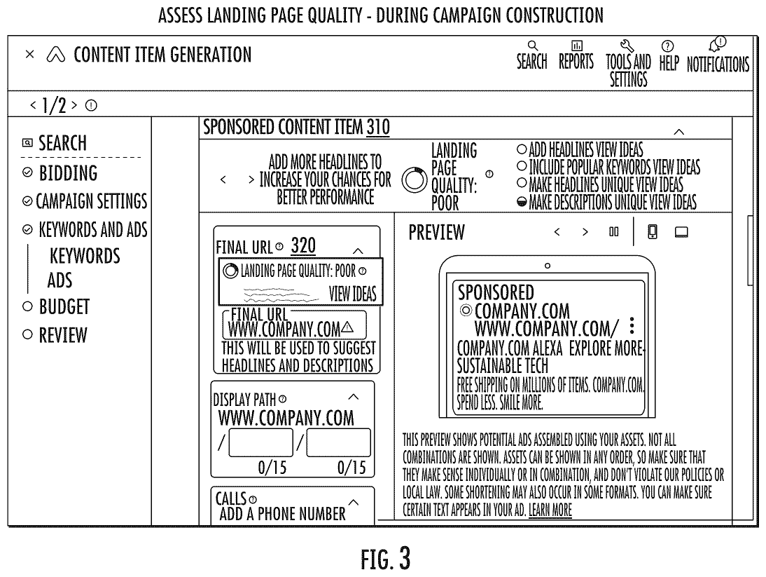

FIG. 3 depicts an example illustration of assessing landing page quality during campaign construction.

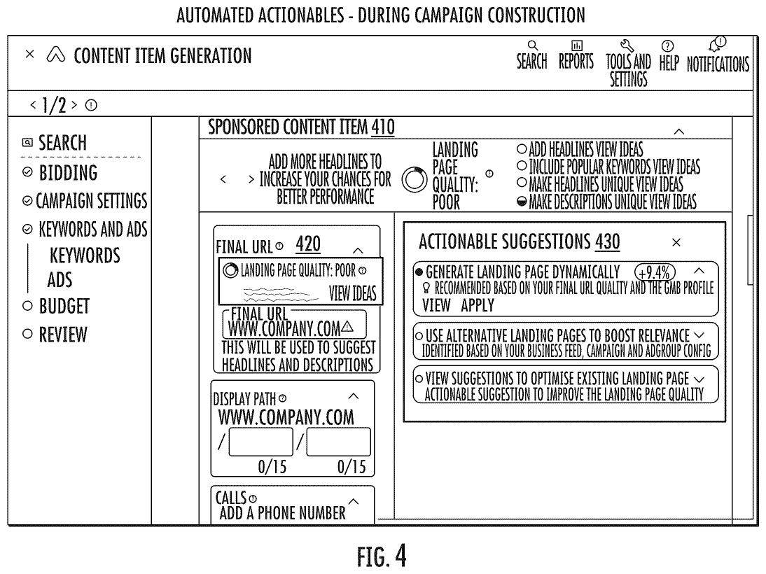

FIG. 4 depicts an example illustration of automated actionable suggestions during campaign construction.

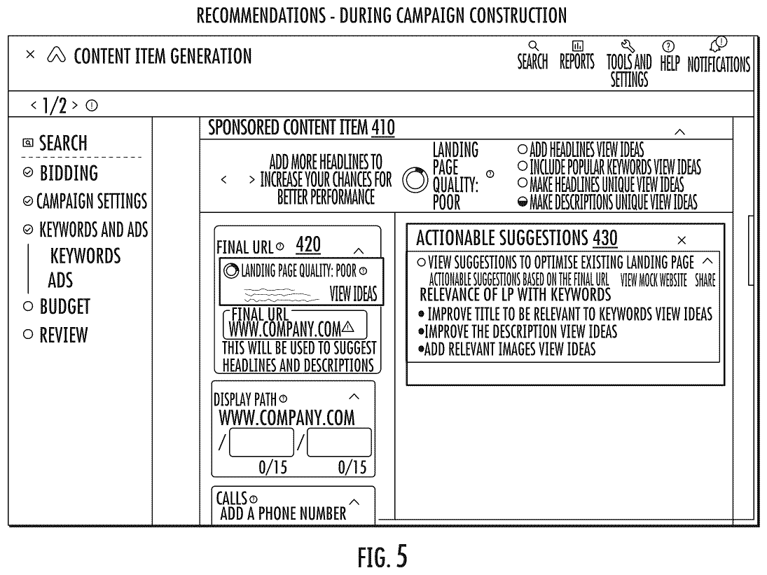

FIG. 5 depicts an example illustration of the system presenting recommendations during campaign construction.

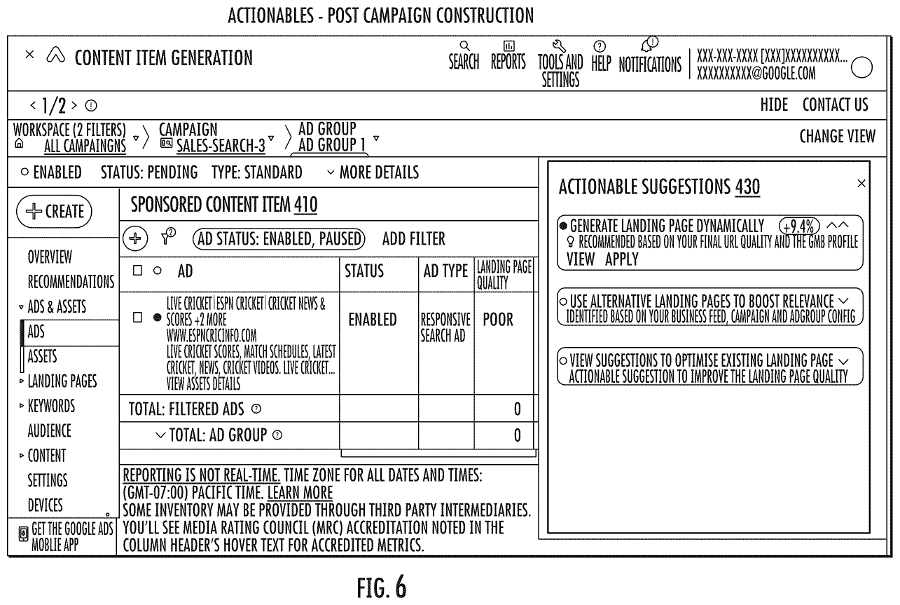

FIG. 6 depicts an example illustration of presenting actionable suggestions after the campaign construction.

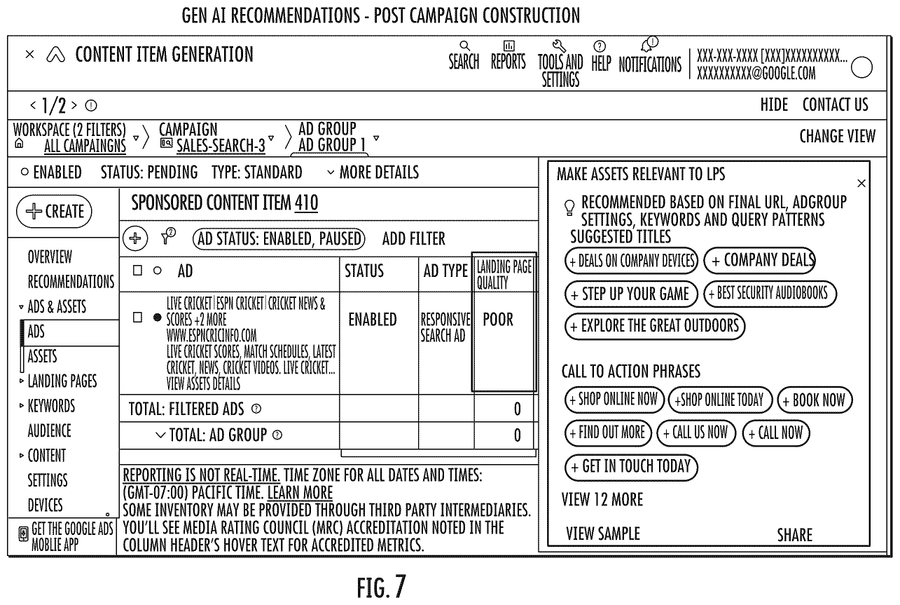

FIG. 7 depicts an example illustration of generating a new web page to be used as the landing page after campaign construction.

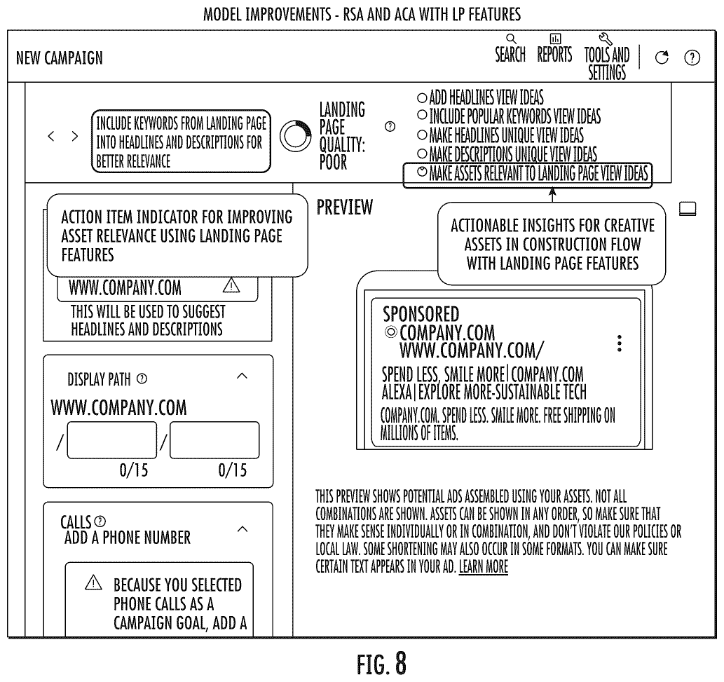

FIG. 8 depicts an example illustration of suggestions to improve assets in the landing page.

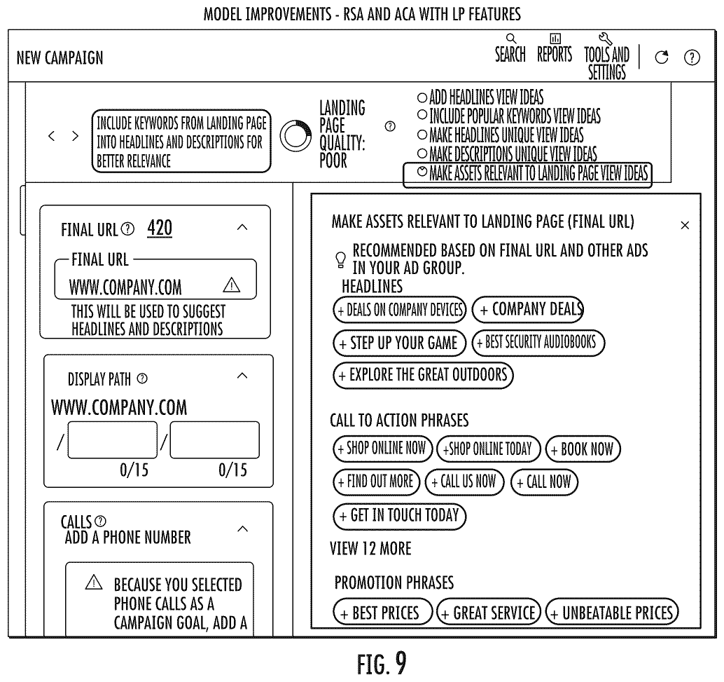

FIG. 9 depicts an example illustration of suggestions to improve assets in the landing page.

### Example Devices and Systems

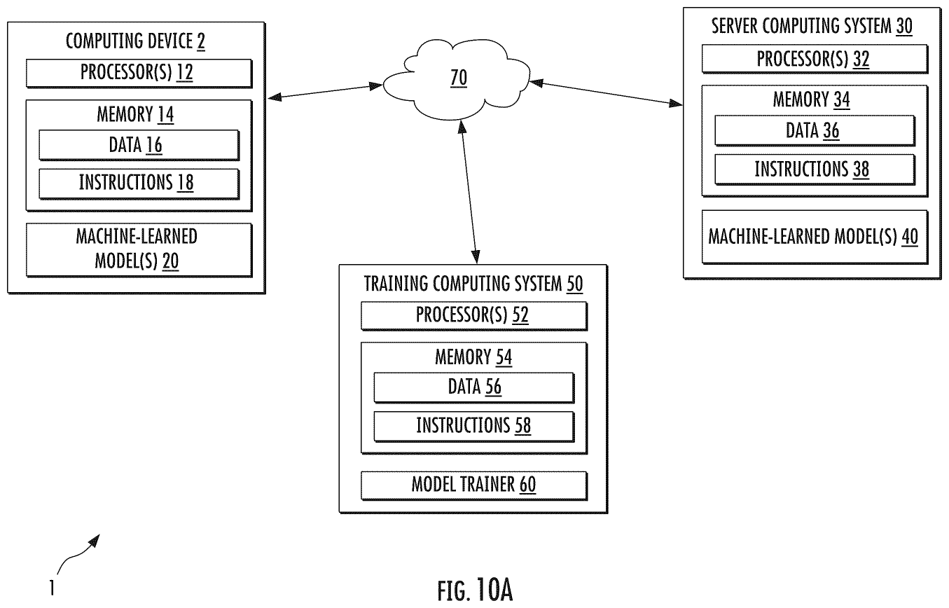

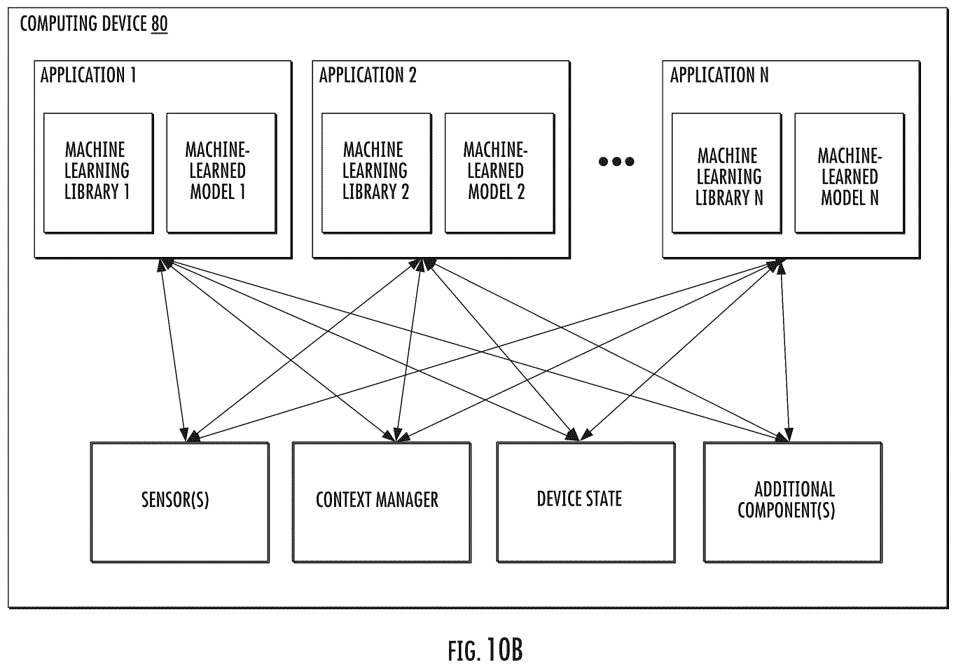

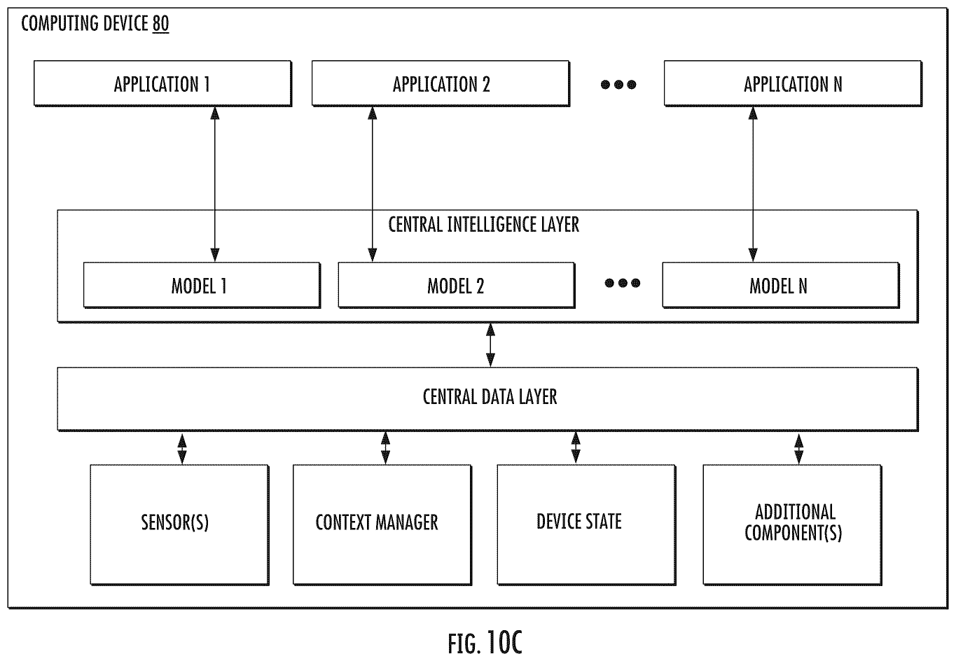

FIG. 10A depicts a block diagram of an example computing system 1 that can perform according to example embodiments of the present disclosure. The system 1 includes a computing device 2, a server computing system 30, and a training computing system 50 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller, etc.) and can be one processor or a plurality of processors that are operatively connected. The memory 14 can include one or more non-transitory computer-readable storage media, such as RAM, ROM, EEPROM, EPROM, flash memory devices, magnetic disks, etc., and combinations thereof. The memory 14 can store data 16 and instructions 18 which are executed by the processor 12 to cause the user computing device 2 to perform operations (e.g., to perform operations implementing input data structures and self-consistency output sampling according to example embodiments of the present disclosure, etc.).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including supervised models or unsupervised models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine- learned model 20.

Additionally, or alternatively, one or more machine-learned models 40 can be included in or otherwise stored and implemented by the server computing system 30 that communicates with the computing device 2 according to a client-server relationship.

Machine-learned model(s) 20 and 40 can include any one or more of the machine-learned models described herein, including the machine-learned asset generation pipeline and any of the component models therein.

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output. In another example, the machine-learned model(s) can extract text from an image (e.g., optical character recognition (OCR)) to understand a call-to-action button or collect other information about the entity. In some instances, the system can extract text from an image using generative artificial intelligence (AI) tools, such as large language models (LLMs). For example, an LLM can generate content (e.g., text) based on inputted media (e.g., images, video, and/or audio).

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., Transcription-a textual representation of the input speech data). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a re-clustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a spoken utterance which is mapped to a text output. In some cases, the task comprises encrypting or decrypting input data. In some cases, the task comprises a microprocessor performance task, such as branch prediction or memory address translation.

In some embodiments, the machine-learned models 40 can be implemented by the server computing system 30 as a portion of a web service (e.g., remote machine-learned model hosting service, such as an online interface for performing machine-learned model operations over a network on remote servers 30). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed, etc.) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing device 2 is a user endpoint associated with a user account of a campaign generation system. The campaign generation system can operate on the server computing system 30.

The server computing system 30 can include one or more processors 32 and a memory 34. The one or more processors 32 can be any suitable processing device (e.g., a processor core, a microprocessor, an ASIC, an FPGA, a controller, a microcontroller, etc.) and can be one processor or a plurality of processors that are operatively connected. The memory 34 can include one or more non-transitory computer-readable storage media, such as RAM, ROM, EEPROM, EPROM, flash memory devices, magnetic disks, etc., and combinations thereof. The memory 34 can store data 36 and instructions 38 which are executed by the processor 32 to cause the server computing system 30 to perform operations.

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 2 or the server computing system 30 can train example embodiments of a machine-learned model (e.g., including models 20 or 40) using a training pipeline (e.g., an unsupervised pipeline, a semi-supervised pipeline, etc.). In some embodiments, the computing device 2 or the server computing system 30 can train example embodiments of a machine-learned model (e.g., including models 20 or 40) using a pre-training pipeline by interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller, etc.) and can be one processor or a plurality of processors that are operatively connected. The memory 54 can include one or more non-transitory computer-readable storage media, such as RAM, ROM, EEPROM, EPROM, flash memory devices, magnetic disks, etc., and combinations thereof. The memory 54 can store data 56 and instructions 58 which are executed by the processor 52 to cause the training computing system 50 to perform operations (e.g., to perform operations implementing input data structures and self-consistency output sampling according to example embodiments of the present disclosure, etc.). In some implementations, the training computing system 50 includes or is otherwise implemented by one or more server computing devices.

The model trainer 60 can include a training pipeline for training machine-learned models using various objectives. Parameters of the image-processing model(s) can be trained, in some embodiments, using various training or learning techniques, such as, for example, backwards propagation of errors. For example, an objective or loss can be back propagated through the pretraining pipeline(s) to update one or more parameters of the model(s) (e.g., based on a gradient of the loss function). Various determinations of loss can be used, such as mean squared error, maximum likelihood error, negative log-likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts, etc.) to improve the generalization capability of the models being trained.

The model trainer 60 can train one or more machine-learned models 20 or 40 using training data (e.g., data 56). The training data can include, for example, historical performance data, past user interactions, and/or past campaigns.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 10A illustrates one example computing system that can be used to implement the present disclosure. Other computing systems can be used as well. For example, in some implementations, the computing device 2 can include the model trainer 60. In some implementations, the computing device 2 can implement the model trainer 60 to personalize the model(s) based on device-specific data.

FIG. 10B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). Example applications include a text messaging application, an email application, a dictation application, a virtual keyboard application, a browser application, etc. As illustrated in FIG. 10B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 10C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 10C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central data layer. The central data layer can be a centralized repository of data for the computing device 80. As illustrated in FIG. 10C, the central device data layer can communicate with a number of other components of the computing device, such as, for example, one or more sensors, a context manager, a device state component, or additional components. In some implementations, the central device data layer can communicate with each device component using an API (e.g., a private API).

### Example Methods

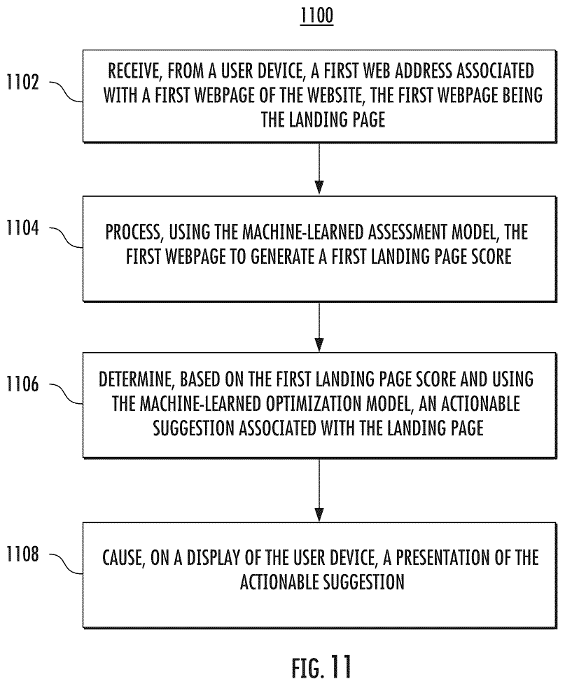

FIG. 11 depicts a flow chart diagram of an example method 1100 to perform according to example embodiments of the present disclosure. Example method 1100 can be implemented by one or more computing systems (e.g., one or more computing systems as discussed with respect to FIGS. 1 to 10C). Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

According to some embodiments, a computing system can include one or more processors and one or more non-transitory computer-readable media. The computer-readable media can collectively store a machine-learned assessment model and a machine-learned optimization model. The machine-learned assessment model can be configured to assess a web page of a website. The machine-learned optimization model can be configured to optimize a landing page of the website.

At 1102, the computing system can receive, from a user device, a first web address associated with a first webpage of the website. The first webpage can be the landing page.

In some instances, the first web page can be a Uniform Resource Locator (URL) of the website.

At 1104, the computing system can process, using the machine-learned assessment model, the first webpage to generate a first landing page score.

In some instances, the first landing page score can be generated by extracting the plurality of assets from the first web page. Each asset in the plurality of assets can be an image, a word, a video, or an audio file. Additionally, the system can process, using the machine-learned optimization model, the plurality of assets to generate the first landing page score.

In some instances, the first landing page score can be generated by extracting the plurality of assets from the first web page. Each asset in the plurality of assets can be an image, a word, a video, or an audio file. Additionally, the system can process, using the machine-learned optimization model, the plurality of assets to generate the first landing page score.

In some instances, the landing page score can be a four-point scale. For example, the landing page score can be either poor, average, good, or excellent.

At 1106, the computing system can determine, based on the first landing page score and using the machine-learned optimization model, an actionable suggestion associated with the landing page.

In some instances, the actionable suggestion can be to modify an asset in the plurality of assets of the first webpage, use a second webpage of the website as the landing page, or generate new web pages based on the plurality of assets. Additionally, the actionable suggestion can be further determined based on the first landing page score exceeding a threshold value.

In some instances, the actionable suggestion can be to dynamically generate a new webpage as the landing page when the first landing page score is below a threshold value. Additionally, the new webpage can be generated using the machine-learned optimization model by extracting the plurality of assets from the first webpage to generate a new asset for the new webpage.

Furthermore, the system can process, using the machine-learned assessment model, the new webpage to generate a new landing page score. Moreover, the system can modify, using the machine-learned optimization model, the new webpage until the new landing page score is above a threshold value. The actionable suggestion can be to update the landing page of the website to the final form of the new webpage generated and updated using the techniques described herein.

In some instances, the actionable suggestion can be to modify an asset in the plurality of assets of the first webpage when the first landing page score is above a threshold value.

At 1108, the computing system can cause, on a display of the user device, a presentation of the actionable suggestion.

In some instances, the system can process, using the machine-learned assessment model, a second webpage of the website to generate a second landing page score. Additionally, the actionable suggestion can be to update the landing page of the website to be the second webpage when the second landing page score is greater than the first landing page score.

In some instances, the system can process, using the machine-learned assessment model, a second webpage of the website to generate a second landing page score. Additionally, the actionable suggestion can be to maintain the landing page of the website to be the first web page when the second landing page score is less than the first landing page score.

In some instances, the first landing page score can be generated by extracting the plurality of assets from the first web page. Each asset in the plurality of assets can be an image, a word, a video, or an audio file. Additionally, the system can process, using the machine-learned optimization model, the plurality of assets to generate the first landing page score.

In some instances, the landing page score can be a four-point scale. For example, the landing page score can be either poor, average, good, or excellent. In some instances, the landing page score can be a five-point scale.

In some instances, the system can receive a user interaction on a graphical user interface of the display. The user interaction can be associated with a response to the actionable suggestion. Additionally, the system can perform, using the machine-learned optimization model, an action based on the user interaction. Moreover, one or more parameters of the machine-learned assessment model and the machine-learned optimization model can be updated based on the user interaction.

In some instances, the system can receive a user interaction on the graphical user interface. For example, the user interaction can be to reject the actionable suggestion. Additionally, one or more parameters of the machine-learned optimization model are updated based on the user interaction.

In some instances, the first landing page score is based on a relevance sub-score, the relevance sub-score being based on a relevance of the first webpage and a sponsored content having the first web address associated with the first webpage.

In some instances, the first landing page score is based on a content quality sub-score, the content quality sub-score based on attributes of the plurality of assets of the first webpage.

In some instances, the first landing page score is based on a trust sub-score associated with a trust factor of the first webpage.

In some instances, the first landing page score is based on a load time sub-score, a mobile responsiveness sub-score, and a call-to-action sub-score. The load-time sub-score can be based on an amount of time it takes for the first webpage to load on the display of the user device. The mobile responsiveness sub-score is based on an amount of time it takes for the first webpage to load on a mobile device. The call-to-action sub-score can be based on the accuracy and/or relevance of an action associated with a call-to-action button.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example of how implementations can operate or be configured is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Also, terms such as “based on” should be understood as “based at least in part on.”

What is claimed is:

1. A computing system, comprising:
one or more processors; and
one or more non-transitory computer-readable media that collectively store:
a machine-learned assessment model, wherein the machine-learned assessment model is configured to assess a web page of a website;
a machine-learned optimization model, wherein the machine-learned optimization model is configured to optimize a landing page of the website; and
instructions that, when executed by the one or more processors, cause the computing system to perform operations, the operations comprising:
receiving, from a user device, a first web address associated with a first webpage of the website, the first webpage being the landing page;
processing, using the machine-learned assessment model, the first webpage to generate a first landing page score, wherein the first landing page score is calculated based on plurality of assets of the first webpage;
determining, based on the first landing page score and using the machine-learned optimization model, an actionable suggestion associated with the landing page; and
causing, on a display of the user device, a presentation of the actionable suggestion.

2. The computing system of claim 1, wherein the actionable suggestion is to modify an asset in the plurality of assets of the first webpage, use a second webpage of the website as the landing page, or generate a new webpage based on the plurality of assets.

3. The computing system of claim 2, wherein the actionable suggestion is further determined based on the first landing page score exceeding a threshold value.

4. The computing system of claim 1, the operations further comprising:
processing, using the machine-learned assessment model, a second webpage of the website to generate a second landing page score;
wherein the actionable suggestion is to update the landing page of the website to be the second webpage when the second landing page score is greater than the first landing page score.

5. The computing system of claim 1, the operations further comprising:
processing, using the machine-learned assessment model, a second webpage of the website to generate a second landing page score;
wherein the actionable suggestion is to maintain the landing page of the website to be the first webpage when the second landing page score is less than the first landing page score.

6. The computing system of claim 1, wherein the actionable suggestion is to dynamically generate a new webpage as the landing page when the first landing page score is below a threshold value.

7. The computing system of claim 6, wherein the new webpage is generated using the machine-learned optimization model by extracting the plurality of assets from the first webpage to generate a new asset for the new webpage.

8. The computing system of claim 6, the operations further comprising:
processing, using the machine-learned assessment model, the new webpage to generate a new landing page score; and
modify, using the machine-learned optimization model, the new webpage until the new landing page score is above a threshold value,
wherein the actionable suggestion is to update the landing page of the website to be the new webpage.

9. The computing system of claim 1, wherein the first landing page score is generated by:
extracting the plurality of assets from the first web page, wherein each asset in the plurality of assets is an image, a word, a video, or an audio file; and
processing, using the machine-learned optimization model, the plurality of assets to generate the first landing page score.

10. The computing system of claim 1, wherein the actionable suggestion is to modify an asset in the plurality of assets of the first webpage when the first landing page score is above a threshold value.

11. The computing system of claim 1, wherein the landing page score is a four-point scale, and wherein the four-point scale is poor, average, good, or excellent.

12. The computing system of claim 1, the operations further comprising:
receiving a user interaction on a graphical user interface of the display, the user interaction associated with a response to the actionable suggestion; and
performing, using the machine-learned optimization model, an action based on the user interaction; and
wherein one or more parameters of the machine-learned assessment model and the machine-learned optimization model are updated based on the user interaction.

13. The computing system of claim 1, the operations further comprising:
receiving a user interaction on a graphical user interface, the user interaction rejecting the actionable suggestion,
wherein one or more parameters of the machine-learned optimization model are updated based on the user interaction.

14. The computing system of claim 1, wherein the first web page is a Uniform Resource Locator (URL) of the website.

15. The computing system of claim 1, wherein the first landing page score is based on a relevance sub-score, the relevance sub-score being based on a relevance of the first webpage and a sponsored content having the first web address associated with the first webpage.

16. The computing system of claim 1, wherein the first landing page score is based on a content quality sub-score, the content quality sub-score based on attributes of the plurality of assets of the first webpage.

17. The computing system of claim 1, wherein the first landing page score is based on a trust sub-score associated with a trust factor of the first webpage.

18. The computing system of claim 1, wherein the first landing page score is based on a load time sub-score, a mobile responsiveness sub-score, and a call-to-action sub-score, wherein the load time sub-score based on an amount of time it takes for the first webpage to load on the display of the user device, the mobile responsiveness sub-score is based on an amount of time it takes for the first webpage to load on a mobile device, and the call-to-action sub-score is based on a relevance of an action associated with a call-to-action button.

19. A computer-implemented method, comprising:
receiving, from a user device, a first web address associated with a first webpage of the website, a first webpage being a landing page;
processing, using a machine-learned assessment model, the first webpage to generate a first landing page score, wherein the machine-learned assessment model is configured to calculate the first landing page score based on assets of the first webpage;
determining, based on the first landing page score and using a machine-learned optimization model, an actionable suggestion associated with the landing page, wherein the machine-learned optimization model is configured to optimize the landing page; and
causing, on a display of the user device, a presentation of the actionable suggestion.

20. One or more non-transitory, computer readable media storing instructions that are executable by one or more processors to cause a computing system to perform operations, the operations comprising:
receiving, from a user device, a first web address associated with a first webpage of the website, a first webpage being a landing page;
processing, using a machine-learned assessment model, the first webpage to generate a first landing page score, wherein the machine-learned assessment model is configured to calculate the first landing page score based on assets of the first webpage;
determining, based on the first landing page score and using a machine-learned optimization model, an actionable suggestion associated with the landing page, wherein the machine-learned optimization model is configured to optimize the landing page; and
causing, on a display of the user device, a presentation of the actionable suggestion.
